(19) United States
(12) Patent Application Publication
(10) Pub. No.: US 2026/0149261 A1
(43) Pub. Date: May 28, 2026

(54) POWER SUPPLY CONTROL APPARATUS, POWER SUPPLY CONTROL METHOD, AND COMPUTER PROGRAM

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventors: Ryohei SAWADA, Yokkaichi-shi, Mie (JP); Kota ODA, Yokkaichi-shi, Mie (JP); Koki SAKAKIBARA, Yokkaichi-shi, Mie (JP)

(73) Assignees: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(21) Appl. No.: 19/121,601

(22) PCT Filed: Oct. 2, 2023
(86) PCT No.: PCT/JP2023/035827

§ 371 Date: Apr. 16, 2025

(30) Foreign Application Priority Data
Oct. 21, 2022 (JP) 2022-169155

(51) Int. Cl. H02H 5/04; H02H 1/00

(52) U.S. Cl. CPC H02H 5/04; H02H 1/0092

(57) ABSTRACT

A power supply control apparatus for a vehicle controls power supply to a load based on a result of a temperature estimation for an electric wire connected to the load. The power supply control apparatus includes: a change unit configured to change a parameter of the temperature estimation in accordance with the load; and an estimation unit configured to perform the temperature estimation using the changed parameter.

### CROSS-REFERENCE TO RELATED APPLICATIONS

This application is the U.S. national stage of PCT/JP2023/035827 filed on Oct. 2, 2023, which claims priority of Japanese Patent Application No. JP 2022-169155 filed on Oct. 21, 2022, the contents of which are incorporated herein.

### TECHNICAL FIELD

The present disclosure relates to a power supply control apparatus, a power supply control method, and a computer program.

### BACKGROUND

Technologies have conventionally been widely used for preventing smoke from being emitted from an electric wire when the temperature of the electric wire increases due to a short-circuit current that is repeatedly turned on and off in a vehicle.

For example, JP 2009-130944A discloses a power supply control apparatus that detects a current flowing through an electric wire, estimates the current temperature of the electric wire using the detected current, and compares the current temperature of the electric wire with an allowable upper limit temperature of the electric wire, thereby interrupting the flowing current before the electric wire reaches a smoking temperature to prevent smoke from being emitted from the electric wire.

However, the current value used for driving the load differs depending on the load, so that an electric wire for power supply connected to the load also needs to be changed in accordance with the load. Further, a parameter used to estimate the aforementioned wire temperature also depends on the wire, so that it is necessary to prepare a power supply control apparatus with a different parameter for each load in advance. That is, the number of product types of power supply control apparatuses increases, which will lead to an increase in the manufacturing cost.

Further, if a load is changed or added and the electric wire to be connected is replaced after the vehicle is shipped, the parameter used to estimate the wire temperature remains at the time when the vehicle was shipped, and the wire temperature cannot be estimated correctly.

However, the power supply control apparatus disclosed in JP 2009-130944A is not devised to solve such problems.

The present disclosure has been made in view of the foregoing circumstances, and aims to provide a power supply control apparatus, a power supply control method, and a computer program that enable correct estimation of the wire temperature for a plurality of types of loads having different drive current values.

### SUMMARY

A power supply control apparatus according to an embodiment of the present disclosure is a power supply control apparatus for a vehicle that controls power supply to a load based on a result of a temperature estimation for an electric wire, and includes: a change unit configured to change a parameter of the temperature estimation in accordance with the load; and an estimation unit configured to perform the temperature estimation using the changed parameter.

A power supply control method according to an embodiment of the present disclosure is a power supply control method to be performed by a power supply control apparatus for a vehicle that controls power supply to a load based on a result of a temperature estimation for an electric wire, and includes: changing a parameter of the temperature estimation in accordance with the load; performing the temperature estimation using the changed parameter; and turning on or off the power supply based on a result of the temperature estimation.

A computer program according to an embodiment of the present disclosure is a computer program for a power supply control apparatus for a vehicle that controls power supply to a load based on a result of a temperature estimation for an electric wire to control the power supply, the computer program causing a computer to execute processing including: changing a parameter of the temperature estimation in accordance with the load; performing the temperature estimation using the changed parameter; and turning on or off the power supply based on a result of the temperature estimation.

### Advantageous Effects

According to the present disclosure, a correct wire temperature can be estimated even for a plurality of types of loads having different drive current values.

### BRIEF DESCRIPTION OF DRAWINGS

FIG. 1 is a conceptual diagram that schematically shows a power supply control apparatus according to Embodiment 1 installed in a vehicle and a load connected to the power supply control apparatus.

FIG. 2 is a functional block diagram that conceptually describes functional processes of a microcomputer of the power supply control apparatus.

FIG. 3 is a table that conceptually describes an example of the content stored in a storage unit.

FIG. 4 is a flowchart that describes processing by which the power supply control apparatus of Embodiment 1 controls power supply based on an estimated temperature of a load-side wire.

FIG. 5 is a conceptual diagram that schematically shows a power supply control apparatus according to Embodiment 2 installed in a vehicle and a load connected to the power supply control apparatus.

FIG. 6 is a conceptual diagram that schematically describes a power supply control apparatus according to Embodiment 3 installed in a vehicle and a load connected to the power supply control apparatus.

FIG. 7 is a flowchart that describes processing for changing a wire parameter in a power supply control apparatus of Embodiment 4.

### ADVANTAGEOUS EFFECTS OF PRESENT DISCLOSURE

According to the present disclosure, a correct wire temperature can be estimated even for a plurality of types of loads having different drive current values.

### DETAILED DESCRIPTION OF PREFERRED EMBODIMENTS

Firstly, modes for carrying out the present disclosure will be listed and described. Note that at least a part of the following embodiments may optionally be combined with other parts.

In a first aspect, a power supply control apparatus according to an embodiment of the present disclosure is a power supply control apparatus for a vehicle that controls power supply to a load based on a result of a temperature estimation for an electric wire, and includes: a change unit configured to change a parameter of the temperature estimation in accordance with the load; and an estimation unit configured to perform the temperature estimation using the changed parameter.

In such as aspect, when, for example, a load is replaced, the change unit changes the parameter of the temperature estimation in accordance with the replaced load, and the estimation unit estimates the temperature using the changed parameter. Accordingly, the correct wire temperature can be estimated even when the replaced load has a different drive current value.

In a second aspect, the power supply control apparatus according to an embodiment of the present disclosure further includes an acquisition unit configured to acquire specifying information related to the parameter, wherein the change unit is configured to change the parameter based on the specifying information acquired by the acquisition unit.

In such as aspect, when, for example, a load is replaced, the acquisition unit acquires specifying information corresponding to the replaced load, and the change unit changes the parameter based on the specifying information acquired by the acquisition unit. Accordingly the correct wire temperature can be estimated even when the load is replaced.

In a third aspect, in the power supply control apparatus according to an embodiment of the present disclosure, the acquisition unit is configured to acquire the specifying information from outside the vehicle via a receiving unit provided in the vehicle.

In such an aspect, when, for example, a load is replaced, the acquisition unit acquires specifying information corresponding to the replaced load from outside the vehicle via the receiving unit, and the change unit changes the parameter based on the specifying information acquired by the acquisition unit. Accordingly the correct wire temperature can be estimated even when the load is replaced.

In a fourth aspect, the power supply control apparatus according to an embodiment of the present disclosure further includes a storage unit configured to store the specifying information corresponding to each of a plurality of types of loads that are connectable to the power supply control apparatus, wherein the acquisition unit is configured to acquire the specifying information from a communication unit associated with the load, and the change unit is configured to change the parameter based on the specifying information acquired from the communication unit and content stored in the storage unit.

In such as aspect, when, for example, a load is replaced, the acquisition unit acquires specifying information corresponding to the replaced load from the communication unit, and the change unit changes the parameter based on the specifying information acquired by the acquisition unit and the content stored in the storage unit. Accordingly, the correct wire temperature can be estimated even when the load is replaced.

In a fifth aspect, in the power supply control apparatus according to an embodiment of the present disclosure, the specifying information is at least one of a current value for driving the load, a current value associated with a switch for turning on or off the power supply, and information related to the electric wire.

In such as aspect, the specifying information may be, for example, the current value for driving the load, the current value of the current flowing through the switch that turns on or off the power supply, or information related to the electric wire (e.g., the diameter thereof).

In a sixth aspect, in the power supply control apparatus according to an embodiment of the present disclosure, the specifying information includes a current value for driving the load, the power supply control apparatus further includes: a storage unit configured to store the current value of each of a plurality of types of loads connectable to the power supply control apparatus; and a current detection unit configured to detect a current value during a first current flow between the power supply control apparatus and the load, wherein the change unit is configured to change the parameter based on an acquired current value acquired from the current detection unit and content stored in the storage unit.

In such as aspect, when, for example, the load is replaced, the acquisition unit acquires a current value for driving the replaced load from the current detection unit, and the change unit changes the parameter based on the current value acquired by the acquisition unit and the content stored in the storage unit. Accordingly, the correct wire temperature can be estimated even when the load is replaced.

In a seventh aspect, the power supply control apparatus according to an embodiment of the present disclosure the acquisition unit is configured to acquire the specifying information via a communication unit associated with the load, the specifying information includes a current value for driving the load, the power supply control apparatus further includes: a current detection unit configured to detect a current value during a first current flow between the power supply control apparatus and the load; and a determination unit configured to determine whether or not communication with the communication unit is possible, and the acquisition unit is configured to acquire the specifying information from the communication unit or acquires the current value from the current detection unit in accordance with a result of determination by the determination unit.

In such as aspect, when, for example, the load is replaced, the determination unit determines whether or not communication with the communication unit is possible. If it is determined that communication is possible, the acquisition unit acquires the specifying information from the communication unit, and if it is determined that communication is not possible, the acquisition unit acquires the current value from the current detection unit. Accordingly it is possible to address the case where there is no communication unit associated with the replaced load, or the case where there is a communication unit but the acquisition unit cannot acquire the specifying information from the communication unit for some reason.

In an eighth aspect, in the power supply control apparatus according to an embodiment of the present disclosure, the acquisition unit is configured to acquire the specifying information via a communication unit associated with the load, and the acquisition unit is configured to invalidate the specifying information acquired from the communication unit when acquiring the specifying information from the receiving unit.

In such as aspect, when, for example, the load is replaced, the specifying information is acquired via the communication unit associated with the load. When the specifying information is acquired from an operator or the like via the receiving unit, the specifying information acquired by the acquisition unit from the communication unit is invalidated. The change unit changes the parameter using the specifying information from the receiving unit, and the estimation unit estimates the temperature using the changed parameter. Thus, the accuracy of temperature estimation can be improved.

In a ninth aspect, the power supply control apparatus according to an embodiment of the present disclosure further includes a semiconductor switch configured to turn on or off the power supply, wherein the semiconductor switch has an on-resistance corresponding to a largest current value out of current values for driving a plurality of types of loads connectable to the power supply control apparatus.

In such as aspect, the semiconductor switch has an on-resistance corresponding to the largest current value. This allows the semiconductor switch and the output wire to deal with any load replaced.

In a tenth aspect, a power supply control method according to an embodiment of the present disclosure is a power supply control method to be performed by a power supply control apparatus for a vehicle that controls power supply to a load based on a result of a temperature estimation for an electric wire, and includes: changing a parameter of the temperature estimation in accordance with the load; performing the temperature estimation using the changed parameter; and turning on or off the power supply based on a result of the temperature estimation.

In an eleventh aspect, a computer program according to an embodiment of the present disclosure is a computer program for a power supply control apparatus for a vehicle that controls power supply to a load based on a result of a temperature estimation for an electric wire to control the power supply the computer program causing a computer to execute processing including: changing a parameter of the temperature estimation in accordance with the load; performing the temperature estimation using the changed parameter; and turning on or off the power supply based on a result of the temperature estimation.

In such as aspect, when, for example, a load is replaced, the parameter of the temperature estimation is changed in accordance with the load after replacement, and the temperature is estimated using the changed parameter. Accordingly, the correct wire temperature can be estimated even when the replaced load has a different drive current value.

A power supply control apparatus, a power supply control method, and a computer program according to the embodiments of the present disclosure will be described below with reference to the drawings. Note that the present disclosure is not limited to these examples but is defined by the claims, and is intended to include all changes made within the meaning and scope equivalent to the claims.

### Embodiment 1

Conventionally a power supply control apparatus is interposed between a power source such as a battery and a load such as a seat or a door in a vehicle. The power supply control apparatus is an apparatus that turns on or off power supply from the power source to the load as needed.

The power supply control apparatus has a fuse that cuts off power supply to the load. When, for example, the temperature of an electric wire increases excessively due to a short-circuit current that is repeatedly turned on and off, the fuse cuts off power supply to the load in order to prevent smoke from being emitted from the electric wire.

In recent years, the power supply control apparatus includes a semiconductor switch as the fuse, estimates the temperature of an electric wire during current flow, and compares the estimated temperature of the electric wire with an allowable upper limit temperature of the electric wire. Thus, the semiconductor switch cuts off power supply before the electric wire reaches a smoking temperature.

Known methods for estimating the temperature of an electric wire during current flow include a method of estimating the temperature of the electric wire from the sum of a heat generation amount and a heat radiation amount of the electric wire. More specifically the temperature of the electric wire can be estimated by detecting the current flowing through the electric wire, using the following Equation 1:

$$Δ Tw = A \times {I}^{2} \times \{ 1 - exp ( - t / τ ) \} \qquad Equation 1$$

$$Δ Tw : Temperature rise of electric wire from reference temperature ( ° C . )$$

$$I : Detected current value ( A )$$

$$τ : Thermal time constant of electric wire ( s ) ( fixed value )$$

$$t : Time ( s )$$

$$A : Wire parameter$$

Here, A denotes a characteristic of an electric wire connected to a load corresponding to the power supply control apparatus. That is, the wire parameter A depends on the electric wire connected to the load. For example, the wire parameter A is a fixed value that depends on Rw (wire resistance (Ω)) and Rthw (wire thermal resistance (° C./W)).

However, the type of electric wire connected to the load, e.g., the thickness (diameter) of the electric wire is chosen in accordance with a drive current value necessary for driving the load. That is, as the drive current value increases, an electric wire having a larger diameter is required. Also, the allowable upper limit temperature of the electric wire depends on the type of electric wire. Further, the drive current value also depends on whether the load is a seat or a door. Moreover, even for the same seat, the drive current value depends on whether the seat has a USB (Universal Serial Bus) charging function, a heater function, a power seat function, or the like.

Since the type of electric wire (wire diameter) is chosen in accordance with the load as described above, the setting of the wire parameter A of the power supply control apparatus is determined in accordance with the load connected to the power supply control apparatus when the power supply control apparatus is installed in the vehicle.

In addition, it is necessary to vary the diameter of the electric wire connected to the load in accordance with the load that is expected to be connected, and it is also necessary to select a semiconductor switch having a different capacity in the power supply control apparatus. That is, it is necessary to prepare a plurality of types of power supply control apparatuses having semiconductor switches with different capacities in advance, which will lead to an increase in the number of product types of power supply control apparatuses.

It can also happen that a function is added to a load, or a further load is added, for example, after the power supply control apparatus is installed in the vehicle, that is, after the shipment from the factory. In this case, the drive current value increases with the addition of the load function or the addition of the further load, and the electric wire needs to be changed to one with a large wire diameter accordingly. That is, the wire parameter A of the above Equation 1 may actually change due to the electric wire (wire diameter) being changed. However, the wire parameter A of the power supply control apparatus remains at the value set at the time of shipment, and the power supply control apparatus cannot correctly estimate the temperature of the electric wire, which may result in a risk of malfunction.

To address this, the power supply control apparatus of Embodiment 1 described below is configured to solve the above problem. A detailed description will be given below.

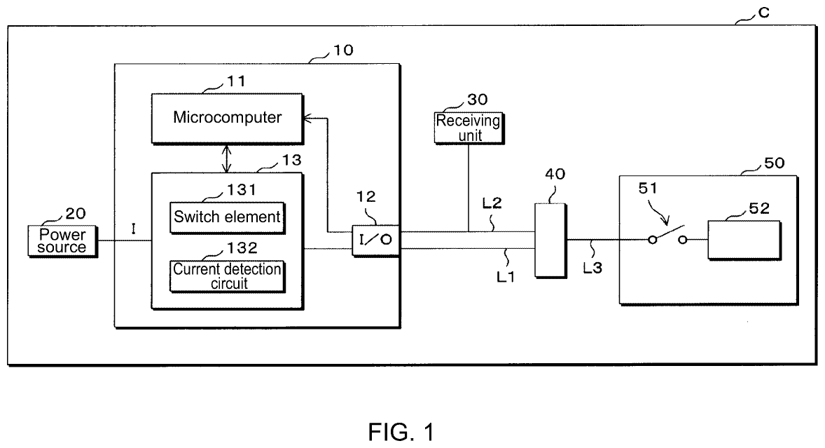

FIG. 1 is a conceptual diagram that schematically shows a power supply control apparatus 10 according to Embodiment 1 installed in a vehicle C and a load 52 connected to the power supply control apparatus 10. The load 52 is, for example, at least one of a USB charger, a heater, and a power seat motor provided in a seat 50.

The vehicle C includes a power source 20, the power supply control apparatus 10, and the seat 50. The seat 50 includes the load 52, and the power supply control apparatus 10 is interposed between the power source 20 and the load 52. In other words, the power source 20 is connected to the load 52 via the power supply control apparatus 10.

A connector 40 is interposed between the power supply control apparatus 10 and the seat 50 (load 52). The power supply control apparatus 10 and the connector 40 are connected by an electric wire L1 (output wire) for power supply, and the connector 40 and the load 52 are connected by an electric wire L3 for power supply. For example, the connector 40 is installed at a boundary portion between the floor and the seat 50 in the vehicle C. The power source 20 side corresponds to the upstream side of the connector 40, and the load side corresponds to the downstream side of the connector 40. In the following, the electric wire L1 is also referred to as a power source-side wire L1, and the wire L3 is also referred to as a load-side wire L3.

The wire diameter of the load-side wire L3 is smaller than or equal to the wire diameter of the power source-side wire L1. More specifically the power source-side wire L1 has a wire diameter corresponding to a drive current value of a load having the largest drive current value among all loads expected to be connected to the power supply control apparatus 10. For example, when loads 1 to 4 having different drive current values can be connected to the power supply control apparatus 10, and the load 4 has the largest drive current value, the power source-side wire L1 has a wire diameter corresponding to the drive current value of the load 4.

Thus, when a function is added to the load or a further load is added, the load-side wire L3 needs to be replaced as mentioned above, but the power source-side wire L1 does not need to be replaced.

The power supply control apparatus 10 and the connector 40 are connected by a communication line L2. Hereinafter, the communication line L2 is also referred to as a power source-side communication line L2.

A receiving unit 30 for receiving input of load information (specifying information) from outside the vehicle C is connected to the power source-side communication line L2. Here, the load information is information related to a wire parameter A, e.g., information specifying the load 52 connected to the power supply control apparatus 10. The load information may specifically be data representing the product number of the load 52, data representing the aforementioned drive current value associated with the load 52, or data representing the wire diameter of the load-side wire L3 corresponding to that drive current value. The load information may also be data representing Rw and Rthw.

The receiving unit 30 receives input of the load information when the vehicle C is shipped, or receives input of the load information from a vehicle maintenance operator who may be a regular dealer or the like responsible for maintenance work of the vehicle C, such as replacement of an ECU.

The receiving unit 30 may have a communication unit (not shown) and may be capable of receiving the load information from outside the vehicle C by means of wireless communication using OTA (Over The Air) technology.

In the following, it is assumed that the receiving unit 30 receives input of the load information from a vehicle maintenance operator, and this load information is the drive current value associated with the load 52, for convenience of explanation.

The power supply control apparatus 10 includes a microcomputer 11, an IPS (Intelligence Power Switch) 13, and an I/O (Input/Output interface) 12. The IPS 13 is interposed between the power source 20 and the I/O 12.

The I/O 12 is connected to the power source-side wire L1 and the power source-side communication line L2. That is, current flowing from the power source 20 to the I/O 12 via the IPS 13 flows to the power source-side wire L1. The load information received by the receiving unit 30 is sent to the I/O 12 via the power source-side communication line L2, and is sent from the I/O 12 to the microcomputer 11.

The IPS 13 has a switch element 131 and a current detection circuit 132.

The switch element 131 is, for example, a semiconductor switch element such as an n-channel MOSFET, and turns on or off the current flowing from the power source 20 to the load 52, i.e., the current flowing from the power source 20 to the load 52 during current flow to the load 52 (hereinafter referred to as a “flowing current I”). The switch element 131 turns the aforementioned flowing current I on or off in response to an instruction from the microcomputer 11.

Since the power source-side wire L1 has a wire diameter corresponding to the expected largest drive current value of a load as mentioned above, the switch element 131 also has an on-resistance corresponding to the expected largest drive current value of a load.

The current detection circuit 132 is, for example, a sense MOSFET, and detects a current value of the flowing current I during current flow, and sends the detected current value to the microcomputer 11.

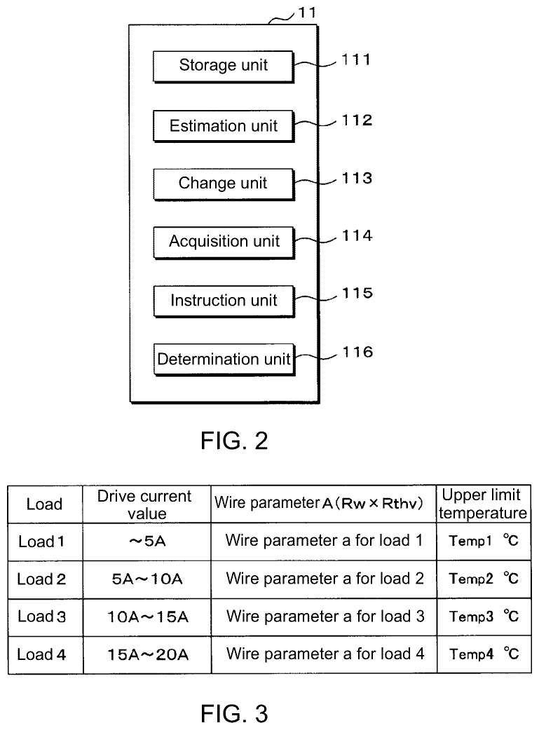

FIG. 2 is a functional block diagram that conceptually describes the functional processes of the microcomputer 11 of the power supply control apparatus 10.

The microcomputer 11 includes a storage unit 111, an estimation unit 112, a change unit 113, an acquisition unit 114, an instruction unit 115, and a determination unit 116. In other words, the microcomputer 11 includes a processing circuit that serves as the storage unit 111, the estimation unit 112, the change unit 113, the acquisition unit 114, the instruction unit 115, and the determination unit 116.

The storage unit 111 stores the above Equation 1. The storage unit 111 also stores a plurality of types of loads connectable to the power supply control apparatus 10 and the load information regarding each load in association with each other.

FIG. 3 is a table that conceptually describes an example of the content stored in the storage unit 111.

For example, it is assumed that the loads 1 to 4 having different drive current values can be connected to the power supply control apparatus 10 as mentioned above. In this case, the storage unit 111 stores the range of the drive current value and the wire parameter A in association with each of the loads 1 to 4. In the following, it is assumed that the wire parameter A is given as “A=Rw×Rthw”. That is, the wire parameter A is the product of the wire resistance and the wire thermal resistance of the load-side wire.

Also, the storage unit 111 stores the upper limit temperature in association with each of the loads 1 to 4. Here, the upper limit temperature is an upper limit temperature allowed for each load-side wire L3 that is determined in accordance with the load.

The estimation unit 112 estimates the temperature of the load-side wire L3. That is, the estimation unit 112 estimates the temperature of the load-side wire L3 using the above Equation 1. More specifically the estimation unit 112 estimates the temperature of the load-side wire L3 using Equation 1 and a reference temperature when the temperature estimation starts, which is set by a reference temperature setting circuit (not shown).

More specifically the current detection circuit 132 detects a current value of the flowing current I supplied to the load 52 via the load-side wire L3 at every predetermined time, and the estimation unit 112 estimates the temperature of the load-side wire L3 by calculating a temperature rise (ΔTw) of the load-side wire L3 from the reference temperature within the predetermined time resulting from the detected flowing current I and adding the calculated temperature rise to the reference temperature.

The acquisition unit 114 acquires the load information related to the load 52 from outside the power supply control apparatus 10. The acquisition unit 114 monitors the I/O 12 and acquires the load information sent from the receiving unit 30. For example, when the receiving unit 30 receives data representing the drive current value associated with the load 52 from the vehicle maintenance operator, the receiving unit 30 transmits the received drive current value to the I/O 12. The I/O 12 sends the received drive current value to the acquisition unit 114.

The change unit 113 changes a parameter associated with estimation of the temperature of the load-side wire L3 in accordance with the load 52. For example, when the acquisition unit 114 acquires the load information related to the load 52 from outside the power supply control apparatus 10, the change unit 113 changes the wire parameter A based on the load information acquired by the acquisition unit 114 and the content stored in the storage unit 111. When the wire parameter A is changed by the change unit 113, the estimation unit 112 estimates the temperature of the load-side wire L3 using the changed wire parameter A.

The determination unit 116 compares the temperature of the load-side wire L3 estimated by the estimation unit 112 (hereinafter referred to as an “estimated temperature of the load-side wire L3) with the upper limit temperature stored in the storage unit 111, and determines whether or not the estimated temperature of the load-side wire L3 is higher than or equal to the upper limit temperature.

If the determination unit 116 determines that the estimated temperature of the load-side wire L3 is higher than or equal to the upper limit temperature, the instruction unit 115 instructs the switch element 131 of the IPS 13 to turn off the flowing current I.

As mentioned above, the seat 50 is connected to the connector 40 via the load-side wire L3. The seat 50 has a switch 51 and the load 52. The switch 51 is interposed between the connector 40 and the load 52.

The processing performed by the power supply control apparatus 10 of Embodiment 1 when the load 52 is changed in the vehicle C will be described below.

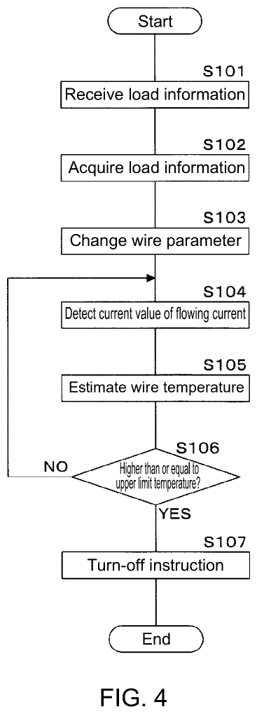

FIG. 4 is a flowchart that describes processing by which the power supply control apparatus 10 of Embodiment 1 controls power supply based on the estimated temperature of the load-side wire L3.

For example, it is possible that the vehicle maintenance operator replaces the load 52 provided in the seat 50 of the vehicle C from the load 1 to the load 2, which has a larger drive current value, as needed. The vehicle maintenance operator first turns off the switch 51, then replaces the load 1 with the load 2, and then turns on the switch 51. In this case, the drive current value increases with the change of the load 52, and therefore the vehicle maintenance operator also changes the load-side wire L3 to a load-side wire L3 having a large wire diameter.

Since the wire (wire diameter) is changed in this manner, the wire parameter A of the above Equation 1 also needs to be changed. Thus, the vehicle maintenance operator inputs the load information regarding the new load 52 after change through the receiving unit 30. For example, the vehicle maintenance operator inputs the drive current value (data) associated with the new load 52, and the receiving unit 30 receives it. (Step S101).

When receiving the drive current value associated with the new load 52 from the vehicle maintenance operator, the receiving unit 30 transmits the received drive current value to the I/O 12, and the acquisition unit 114 acquires this drive current value via the I/O 12 (step S102).

When the acquisition unit 114 thus acquires the drive current value associated with the new load 52, the change unit 113 changes the wire parameter A based on the drive current value acquired by the acquisition unit 114 and the content stored in the storage unit 111 (step S103).

In this example, the load 1 is changed to the load 2, and therefore the drive current value acquired by the acquisition unit 114 is in the range of 5 A to 10 A. Accordingly, the change unit 113 replaces the wire parameter A of Equation 1 from the wire parameter A corresponding to the current load 1 to the wire parameter A corresponding to the load 2, based on the table of FIG. 3 stored in the storage unit 111.

Thereafter, the current detection circuit 132 detects a current value of the flowing current I supplied to the load 52 via the load-side wire L3 (step S104) and transmits the detected current value of the flowing current I to the microcomputer 11.

When receiving the current value of the flowing current I, the estimation unit 112 estimates the temperature of the new load-side wire L3 using the current value of the flowing current I and the above Equation 1 with the changed wire parameter A (step S105). The estimation of the temperature of the load-side wire L3 has already been described, and its detailed description is omitted.

When the temperature of the load-side wire L3 is estimated, the determination unit 116 determines whether or not the estimated temperature of the load-side wire L3 is higher than or equal to the upper limit temperature based on the upper limit temperature stored in the storage unit 111 (step S106). If the determination unit 116 determines that the estimated temperature of the load-side wire L3 is lower than the upper limit temperature (step S106: NO), processing returns to step S104. For example, a configuration may be employed in which, if the determination unit 116 determines that the estimated temperature of the load-side wire L3 is lower than the upper limit temperature, processing returns to step S104 after a lapse of a predetermined time.

On the other hand, if the determination unit 116 determines that the estimated temperature of the load-side wire L3 is higher than or equal to the upper limit temperature (step S106: YES), the instruction unit 115 instructs the switch element 131 of the IPS 13 to turn off the flowing current I (step S107).

Through the above processing, when the load 52 is changed as mentioned above, the power supply control apparatus 10 of Embodiment 1 estimates the temperature of the load-side wire L3 using the load information regarding the new load 52. Thus, even when the load 52 is changed, the temperature of the load-side wire L3 can be estimated correctly. Accordingly even if, for example, a function is added to the load 52 of the vehicle C or another load 52 is added after shipment from the factory it is possible to prevent smoke from being generated from the load-side wire L3.

As described above, when the load 52 is changed in the power supply control apparatus 10 of Embodiment 1, an existing wire parameter A is changed to a wire parameter A corresponding to the new load 52 using the load information regarding the new load 52 that is received from outside the power supply control apparatus 10 via the receiving unit 30.

Thus, it is possible to deal with replacement to different types of loads 52, and it is not necessary to separately prepare in advance power supply control apparatuses 10 corresponding to a plurality of types of loads 52 connectable to the power supply control apparatus 10. This can reduce the manufacturing cost of the power supply control apparatus 10.

### Embodiment 2

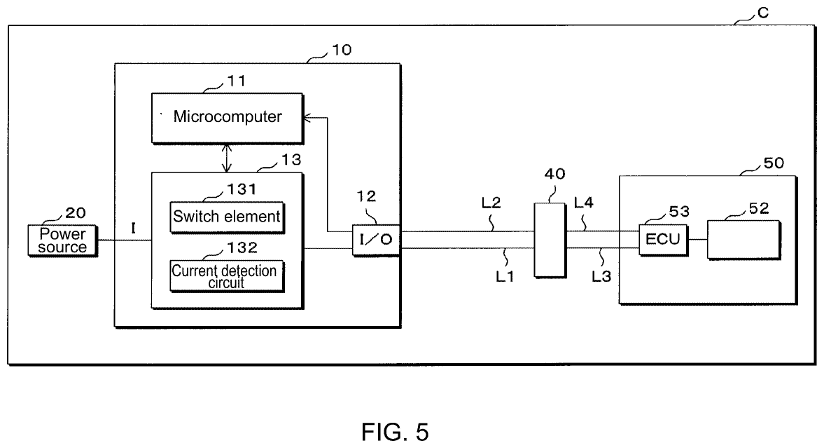

FIG. 5 is a conceptual diagram that schematically shows a power supply control apparatus 10 according to Embodiment 2 installed in a vehicle C and a load 52 connected to the power supply control apparatus 10. As in Embodiment 1, the vehicle C includes a power source 20, a power supply control apparatus 10, and a seat 50, but does not include a receiving unit 30.

The power supply control apparatus 10 is interposed between the power source 20 and the load 52. A connector 40 is interposed between the power supply control apparatus 10 and the seat 50. The power source 20, the power supply control apparatus 10, and the connector 40 are the same as those of Embodiment 1, and their detailed description is omitted.

Meanwhile, the seat 50 is connected to the connector 40 via a load-side wire L3 for power supply. The seat 50 and the connector 40 are connected by a communication line L4. That is, in the case of the power supply control apparatus 10 of Embodiment 2, the power supply control apparatus 10 and the connector 40 are connected by a power source-side communication line L2 on the upstream side of the connector 40, and the connector 40 and the seat 50 are connected by the communication line L4 on the downstream side of the connector 40. In the following, the communication line L4 is also referred to as a load-side communication line L4.

The seat 50 includes an ECU (Electronic Control Unit) 53 and a load 52. The ECU 53 (communication unit) is interposed between the connector 40 and the load 52. That is, the ECU 53 and the connector 40 are connected by the load-side wire L3 and the load-side communication line L4. In other words, the ECU 53 can communicate with the power supply control apparatus 10 via the load-side communication line L4, the connector 40, and the power source-side communication line L2.

The ECU 53 performs power supply control and the like on the load 52. Also, the ECU 53 stores load information specifying the load 52, and transmits the load information to the power supply control apparatus 10 in response to a request from the power supply control apparatus 10, as will be described later.

The load information may be, for example, data representing the product number of the load 52, data representing the drive current value associated with the load, data representing the wire diameter of the load-side wire L3 corresponding to that drive current value, or data representing Rw and Rthw. For convenience, the following description will take as an example a case where the load information is data representing the drive current value.

For example, it is possible that the vehicle maintenance operator replaces the load 52 provided in the seat 50 of the vehicle C from the load 1 to the load 2, which has a larger drive current value. In this case, the drive current value increases with the change of the load 52, and therefore the vehicle maintenance operator also changes the load-side wire L3 to a load-side wire L3 having a large wire diameter.

Processing performed by the power supply control apparatus 10 of Embodiment 2 when the load 52 is changed in the vehicle C as described above will be described below.

When the load 52 is changed from the load 1 to the load 2, the microcomputer 11 of the power supply control apparatus 10 requests the ECU 53 of the seat 50 to send the load information regarding the load 52. In response to this, the ECU 53 transmits the load information regarding the load 52 to the power supply control apparatus 10. At this time, the ECU 53 may transmit the load information (drive current value) regarding the load 52 that is stored in itself to the power supply control apparatus 10, or may detect a current value of the flowing current I flowing through the ECU 53 and transmit the detected current value to the power supply control apparatus 10.

When data representing the drive current value of the load 52 is sent from the ECU 53 of the seat 50, the power supply control apparatus 10 performs the processing in steps S102 to S107 in FIG. 4, as in Embodiment 1.

That is, the acquisition unit 114 acquires the drive current value from the ECU 53 via the I/O 12, and the change unit 113 changes the wire parameter Abased on the drive current value acquired by the acquisition unit 114 and the content stored in the storage unit 111. Thereafter, the current detection circuit 132 detects a current value of the flowing current I supplied to the load 52 via the load-side wire L3, and the estimation unit 112 estimates the temperature of the new load-side wire L3 using the current value of the flowing current I and the above Equation 1 with the changed wire parameter A. Then, the determination unit 116 determines whether or not the estimated temperature of the load-side wire L3 is higher than or equal to the upper limit temperature based on the upper limit temperature stored in the storage unit 111 (see the table in FIG. 3). If the determination unit 116 determines that the estimated temperature of the load-side wire L3 is higher than or equal to the upper limit temperature, the instruction unit 115 instructs the switch element 131 of the IPS 13 to turn off the flowing current I.

With the above-described configuration, similar to Embodiment 1, the power supply control apparatus 10 of Embodiment 2 can also correctly estimate the temperature of the load-side wire L3 even when, for example, a function of the load 52 of the vehicle C is added or the load 52 itself is added after shipment from the factory. This can prevent smoke from being generated from the load-side wire L3.

When the load 52 is changed, the existing wire parameter A is changed to the wire parameter A corresponding to the new load 52 accordingly. Thus, it is possible to deal with replacement to different types of loads 52, and it is not necessary to separately prepare in advance power supply control apparatuses 10 corresponding to a plurality of types of loads 52 connectable to the power supply control apparatus 10. This can reduce the manufacturing cost of the power supply control apparatus 10.

In the above-described example, the power supply control apparatus 10 of Embodiment 2 does not have the receiving unit 30, and acquires the load information regarding the load 52 only from the ECU 53. However, there is no limitation thereto, and the power supply control apparatus 10 may also have the receiving unit 30.

In the case where the power supply control apparatus 10 has both the ECU 53 and the receiving unit 30 in this manner, a configuration is employed in which the load information is preferentially acquired via the receiving unit 30. For example, when the acquisition unit 114 of the power supply control apparatus 10 acquires the load information from outside the vehicle C via the receiving unit 30, the load information acquired from the ECU 53 is invalidated.

That is, the load information received from the vehicle maintenance operator or the load information received using OTA is preferentially used for estimating the temperature of the load-side wire L3. Accordingly the accuracy of temperature estimation can be improved.

Note that the same parts as those of Embodiment 1 are assigned the same reference numerals, and their detailed description is omitted.

### Embodiment 3

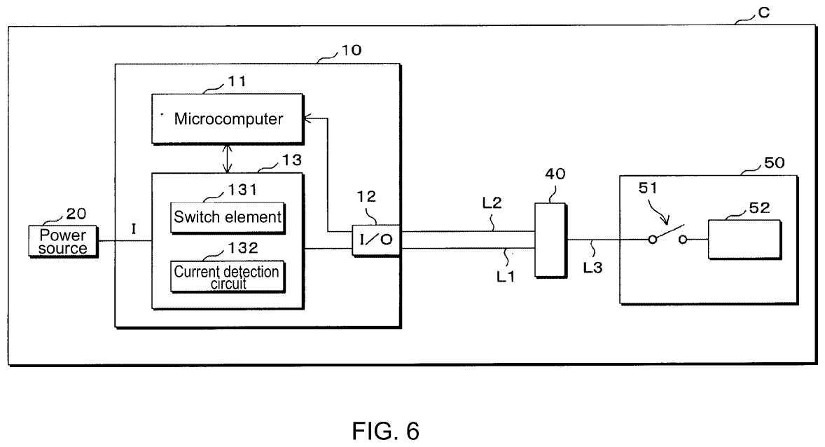

FIG. 6 is a conceptual diagram that schematically shows a power supply control apparatus 10 according to Embodiment 3 installed in a vehicle C and a load 52 connected to the power supply control apparatus 10. As in Embodiment 1, the vehicle C includes a power source 20, a power supply control apparatus 10, and a seat 50, but does not include a receiving unit 30. Other aspects are the same as those of Embodiment 1, and their detailed description is omitted.

For example, it is possible that the vehicle maintenance operator replaces the load 52 provided in the seat 50 of the vehicle C from the load 1 to the load 2, which has a larger drive current value, as needed. In this case, the drive current value increases with the change of the load 52, and therefore the vehicle maintenance operator also changes the load-side wire L3 to a load-side wire L3 having a large wire diameter.

Processing performed by the power supply control apparatus 10 of Embodiment 3 when the load 52 is changed in the vehicle C as described above will be described below.

If the load 1 is replaced with the load 2, the vehicle maintenance operator replaces the load 1 with the load 2 and then turns on the switch 51. This enables power supply from the power source 20 to the load 52.

For example, when the engine of the vehicle C starts, the flowing current I flows from the power source 20 to the load 52. The power supply control apparatus 10 of Embodiment 3 changes the wire parameter Abased on the current value of the flowing current I during the first current flow through the apparatus and the load 52 (hereinafter, “during the first current flow”) and the content stored in the storage unit 111.

That is, during the first current flow through the power supply control apparatus 10 and the load 52, the current detection circuit 132 detects the current value of the flowing current I, and sends the detected current value of the flowing current I to the microcomputer 11 (acquisition unit 114). Thus, the acquisition unit 114 acquires the current value of the flowing current I during the first current flow as the load information. In the following, the current value of the flowing current I acquired by the acquisition unit 114 is referred to as an “acquired flowing current I (acquired current value)”.

When the acquired flowing current I is sent from the current detection circuit 132, the microcomputer 11 performs the processing in steps S102 to S107 in FIG. 4 as in Embodiment 1.

That is, the acquisition unit 114 acquires the acquired flowing current I from the current detection circuit 132, and the change unit 113 changes the wire parameter Abased on the acquired flowing current I acquired by the acquisition unit 114 and the content stored in the storage unit 111. That is, the change unit 113 replaces the current wire parameter A with the wire parameter A corresponding to the range of the drive current value to which the acquired flowing current I belongs in the content stored in the storage unit 111 (see the table in FIG. 3).

Thereafter, the estimation unit 112 estimates the temperature of the new load-side wire L3 using the acquired flowing current I and the aforementioned Equation 1 with the changed wire parameter A. The determination unit 116 then determines whether or not the estimated temperature of the load-side wire L3 is higher than or equal to the upper limit temperature based on the upper limit temperature stored in the storage unit 111. If the determination unit 116 determines that the estimated temperature of the load-side wire L3 is higher than or equal to the upper limit temperature, the instruction unit 115 instructs the switch element 131 of the IPS 13 to turn off the flowing current I.

With the above-described configuration, similar to Embodiment 1, the power supply control apparatus 10 of Embodiment 3 can also correctly estimate the temperature of the load-side wire L3 even if the load 52 of the vehicle C is changed after shipment from the factor. This can prevent smoke from being generated from the load-side wire L3.

When the load 52 is changed, the existing wire parameter A is changed to the wire parameter A corresponding to the new load 52 accordingly. Thus, it is not necessary to separately prepare in advance power supply control apparatuses 10 corresponding to a plurality of types of loads 52 connectable to the power supply control apparatus 10. This can reduce the manufacturing cost of the power supply control apparatus 10.

Note that the same parts as those of Embodiment 1 are assigned the same reference numerals, and their detailed description is omitted.

### Embodiment 4

In the example described above in Embodiment 2, the load information (drive current value) is acquired from the ECU 53 to change the wire parameter A. In the example described above in Embodiment 3, the load information (acquired flowing current I) is acquired from the current detection circuit 132 during the first current flow to change the wire parameter A. However, there is no limitation thereto. For example, the source from which the load information is acquired may be changed depending on the situation.

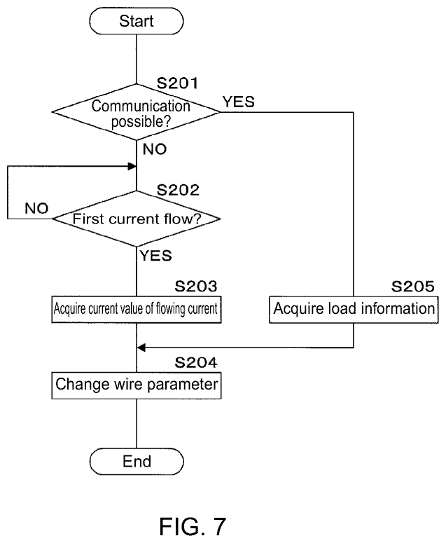

FIG. 7 is a flowchart that describes processing for changing the wire parameter Ain a power supply control apparatus 10 of Embodiment 4.

With the power supply control apparatus 10 of Embodiment 4, the acquisition unit 114 can acquire the load information (drive current value) from the ECU 53, and can also acquire the load information (acquired flowing current I) from the current detection circuit 132. That is, the power supply control apparatus 10 of Embodiment 4 includes the current detection circuit 132, as in FIG. 5, and is connected to the seat 50 that includes the ECU 53 and the load 52. FIG. 5 has already been described, and its detailed description will be omitted.

For example, it is assumed that the vehicle maintenance operator replaces the load 52 in the seat 50 of the vehicle C as needed, and also changes the load-side wire L3 to a load-side wire L3 having a larger wire diameter with the replacement of the load 52.

After the replacement of the load 52 by the vehicle maintenance operator is completed, the determination unit 116 of the power supply control apparatus 10 determines whether or not communication with the ECU 53 of the load 52 is possible (step S201). In other words, the determination unit 116 determines whether or not the ECU 53 is present in the load 52.

More specifically, the microcomputer 11 transmits a signal requesting a response to the seat 50 side, and monitors the I/O 12 as to whether a response signal is received in response to the request for a predetermined time.

If the response signal is received within a predetermined time, the determination unit 116 determines that communication with the ECU 53 of the load 52 is possible, (step S201: YES), and the microcomputer 11 requests the ECU 53 of the seat 50 to send the load information regarding the load 52. In response to this request, the ECU 53 transmits the load information regarding the load 52 to the power supply control apparatus 10, and the acquisition unit 114 acquires the drive current value from the ECU 53 via the I/O 12 (step S205). The processing by which the acquisition unit 114 acquires the drive current value from the ECU 53 has already been described in Embodiment 2, and its detailed description is omitted. Thereafter, the procedure advances to step S204.

On the other hand, if the response signal is not received within the predetermined time period, the determination unit 116 determines that communication with the ECU 53 of the load 52 is not possible (step S201: NO). In other words, the determination unit 116 determines that the ECU 53 is not present in the load 52.

Next, the determination unit 116 determines whether or not the first current flow has occurred between the power supply control apparatus 10 and the load 52 (step S202). If the determination unit 116 determines that the first current flow has not occurred between the power supply control apparatus 10 and the load 52 (step S202: NO), the determination unit 116 waits until the first current flow occurs.

If the determination unit 116 determines that the first current flow has occurred between the power supply control apparatus 10 and the load 52 (step S202: YES), the current detection circuit 132 detects the current value of the flowing current I and sends it to the acquisition unit 114 of the microcomputer 11, and the acquisition unit 114 thus acquires the current value of the flowing current I during the first current flow (step S203). Processing by which the acquisition unit 114 acquires the current value of the flowing current I during the first current flow has already been described in Embodiment 3, and its detailed description is omitted. Thereafter, the procedure advances to step S204.

Through the above processing, the acquisition unit 114 can acquire the load information (the drive current value or the current value of the flowing current I) regarding the new load 52.

Next, the change unit 113 changes the wire parameter Abased on the load information acquired by the acquisition unit 114 and the content stored in the storage unit 111 (step S204). The change of the wire parameter A has already been described, and its detailed description is omitted.

As described above, the power supply control apparatus 10 of Embodiment 4 can change the source from which the load information is acquired, depending on the situation. Thus, the load information can be acquired even when communication with the ECU 53 of the load 52 is not possible or the ECU 53 is not present in the load 52.

With the above-described configuration, the power supply control apparatus 10 of Embodiment 4 also exhibits the same effect as that of Embodiment 1.

The detailed description of the same parts as Embodiment 1 is omitted.

In the above-described examples, the wire parameter A is the product of Rw (wire resistance) and Rthw (wire thermal resistance), but there is no limitation thereto. For example, the wire parameter A may be either Rw or Rthw.

In the above-described examples, one load 52 is connected to the power supply control apparatus 10. However, there is no limitation thereto, and the same effect is exhibited even when a plurality of loads 52 are connected to the power supply control apparatus 10. In this case, the load-side wire is determined in accordance with the sum of the drive current values of the plurality of loads 52 connected to the power supply control apparatus 10. Thus, the wire parameter A may be set using Rw and Rthw associated with a load-side wire corresponding to the sum of the drive current values of the plurality of loads 52.

In the above-described example, an n-channel MOSFET is used as the switch element 131. However, there is no limitation thereto. For example, a p-channel MOSFET or a bipolar transistor may alternatively be used as the switch element 131.

In the above-described example, the current value of the flowing current I is detected by the current detection circuit 132, which is a sense MOSFET. However, there is no limitation thereto. For example, a shunt resistor may also be used to detect the current value of the flowing current I.

The technical features (constituent elements) described in Embodiments 1 to 4 can be combined with each other, and new technical features can be formed by combination.

The embodiments disclosed herein are illustrative in all respects and should not be considered restrictive. The scope of the present disclosure is indicated not by the above-described meanings but by the claims, and is intended to encompass all modifications made within the meaning and scope equivalent to the claims.

The items described in the embodiments can be combined with each other. Further, the independent and dependent claims set forth in the claims can be combined with each other in any and all combinations, regardless of the form of reference. Furthermore, the claims are in a format in which a claim refers to two or more other claims (multi-claim format), but there is no limitation thereto. It is also possible to use a format in which a multi-claim cites at least one multi-claim (multi-multi claims).

1. A power supply control apparatus for a vehicle that controls power supply to a load based on a result of a temperature estimation for an electric wire, the power supply control apparatus comprising:
a change unit configured to change a parameter of the temperature estimation in accordance with the load; and
an estimation unit configured to perform the temperature estimation using the changed parameter.

2. The power supply control apparatus according to claim 1, further including;
an acquisition unit configured to acquire specifying information related to the parameter,
wherein the change unit is configured to change the parameter based on the specifying information acquired by the acquisition unit.

3. The power supply control apparatus according to claim 2, wherein the acquisition unit is configured to acquire the specifying information from outside the vehicle via a receiving unit provided in the vehicle.

4. The power supply control apparatus according to claim 2, further including;
a storage unit configured to store the specifying information corresponding to each of a plurality of types of loads that are connectable to the power supply control apparatus,
wherein the acquisition unit is configured to acquire the specifying information from a communication unit associated with the load, and
the change unit is configured to change the parameter based on the specifying information acquired from the communication unit and content stored in the storage unit.

5. The power supply control apparatus according to claim 2, wherein the specifying information is at least one of a current value for driving the load, a current value associated with a switch for turning on or off the power supply, and information related to the electric wire.

6. The power supply control apparatus according to claim 2,
wherein the specifying information includes a current value for driving the load,
the power supply control apparatus further comprises:
a storage unit configured to store the current value of each of a plurality of types of loads connectable to the power supply control apparatus; and
a current detection unit configured to detect a current value during a first current flow between the power supply control apparatus and the load,
wherein the change unit is configured to change the parameter based on an acquired current value acquired from the current detection unit and content stored in the storage unit.

7. The power supply control apparatus according to claim 2,
wherein the acquisition unit is configured to acquire the specifying information via a communication unit associated with the load,
the specifying information includes a current value for driving the load,
the power supply control apparatus further comprises:
a current detection unit configured to detect a current value during a first current flow between the power supply control apparatus and the load; and
a determination unit configured to determine whether or not communication with the communication unit is possible, and
the acquisition unit is configured to acquire the specifying information from the communication unit or acquires the current value from the current detection unit in accordance with a result of determination by the determination unit.

8. The power supply control apparatus according to claim 3,
wherein the acquisition unit is configured to acquire the specifying information via a communication unit associated with the load, and
the acquisition unit is configured to invalidate the specifying information acquired from the communication unit when acquiring the specifying information from the receiving unit.

9. The power supply control apparatus according to claim 1, further including:
a semiconductor switch configured to turn on or off the power supply,
wherein the semiconductor switch has an on-resistance corresponding to a largest current value out of current values for driving a plurality of types of loads connectable to the power supply control apparatus.

10. A power supply control method to be performed by a power supply control apparatus for a vehicle that controls power supply to a load based on a result of a temperature estimation for an electric wire, the power supply control method comprising:
changing a parameter of the temperature estimation in accordance with the load;
performing the temperature estimation using the changed parameter; and
turning on or off the power supply based on a result of the temperature estimation.

11. A computer program for a power supply control apparatus for a vehicle that controls power supply to a load based on a result of a temperature estimation for an electric wire to control the power supply, the computer program causing a computer to execute processing including:
changing a parameter of the temperature estimation in accordance with the load;
performing the temperature estimation using the changed parameter; and
turning on or off the power supply based on a result of the temperature estimation.

12. The power supply control apparatus according to claim 2, further including;
a semiconductor switch configured to turn on or off the power supply,
wherein the semiconductor switch has an on-resistance corresponding to a largest current value out of current values for driving a plurality of types of loads connectable to the power supply control apparatus.

13. The power supply control apparatus according to claim 3, further including;
a semiconductor switch configured to turn on or off the power supply,
wherein the semiconductor switch has an on-resistance corresponding to a largest current value out of current values for driving a plurality of types of loads connectable to the power supply control apparatus.

14. The power supply control apparatus according to claim 4, further including;
a semiconductor switch configured to turn on or off the power supply,
wherein the semiconductor switch has an on-resistance corresponding to a largest current value out of current values for driving a plurality of types of loads connectable to the power supply control apparatus.

15. The power supply control apparatus according to claim 5, further including;
a semiconductor switch configured to turn on or off the power supply,
wherein the semiconductor switch has an on-resistance corresponding to a largest current value out of current values for driving a plurality of types of loads connectable to the power supply control apparatus.

16. The power supply control apparatus according to claim 6, further including;
a semiconductor switch configured to turn on or off the power supply,
wherein the semiconductor switch has an on-resistance corresponding to a largest current value out of current values for driving a plurality of types of loads connectable to the power supply control apparatus.

17. The power supply control apparatus according to claim 7, further including;
a semiconductor switch configured to turn on or off the power supply,
wherein the semiconductor switch has an on-resistance corresponding to a largest current value out of current values for driving a plurality of types of loads connectable to the power supply control apparatus.

18. The power supply control apparatus according to claim 8, further including;
a semiconductor switch configured to turn on or off the power supply,
wherein the semiconductor switch has an on-resistance corresponding to a largest current value out of current values for driving a plurality of types of loads connectable to the power supply control apparatus.
